(19) United States
(12) Patent Application Publication
(10) Pub. No.: US 2022/0386617 A1
(43) Pub. Date: Dec. 8, 2022

(54) Method for the inhibition of growth including soybeans, navy beans, kidney beans, pinto beans, and black beans that comprises applying an effective amount of 2- chloroethylphosphonic acid.

(71) Applicant: Ray LOOP, Brownsville, TX (US)

(72) Inventor: Ray LOOP, Brownsville, TX (US)

(21) Appl. No.: 17/488,014

(22) Filed: Sep. 28, 2021

Related U.S. Application Data
(60) Provisional application No. 63/197,310, filed on Jun. 4, 2021.

(51) Int. Cl. A01N 57/12; A01N 59/16

(52) U.S. Cl. CPC A01N 57/12; A01N 59/16

(57) ABSTRACT

A method of treating a leguminous plant crop comprises a step of applying a 2-chloroethylphosphonic acid solution to the leguminous plant once a seed stage is observed. The solution of 2-chloroethylphosphonic acid may comprise nitrogen and zinc. The 2-chloroethylphosphonic acid solution may also comprise a spreader-sticker. Application of the 2-chloroethylphosphonic acid solution shortens plant maturation and significantly reduces the timing to reach a harvesting stage.

### PRIORITY CLAIM

This application claims priority to U.S. Provisional Patent Application No. 63/197,310 filed Jun. 4, 2021, which is incorporated in its entirety herein by reference.

### BACKGROUND OF THE INVENTION

### Technical Field

The present invention relates generally to a method of treating crops; and more specifically, to a method of treating a leguminous plant crop.

### History of Related Art

Timing is key when determining when to sow and harvest crops. This is especially true for contra-seasoning seed production or winter nurseries. Many regions with warmer weather and/or larger plot sizes play an important role in the contra-season production of seeds for northern markets. A seed lot may be transported several times and through various regions for production, multiplication, and other forms of processing before it reaches a farm, packaging facility, or target market. Various issues such as weather, transport, and government guidelines can have a great impact on the timing for the harvesting and transport of crops. At times, unforeseen issues such as weather, or even global pandemics, can greatly affect the supply chain of certain crops. For example, a leguminous plant crop may require a waiting period of between about 39 to 45 days before reaching a harvestable state. In the interim any number of factors, such as an early freeze, may dictate a great need to harvest before the minimum 39-day period is reached to meet other deadlines or requirements for the supply chain.

### SUMMARY

There is a need for a method that provides for the ability to quickly harvest a leguminous plant crop, shortening plant maturation and turn arounds times for delivery of desired seeds from the leguminous plants.

Below is a simplified summary of this disclosure meant to provide a basic understanding of the method(s) described herein. This is not an exhaustive overview and is not intended to identify key or critical elements or to delineate the scope of the description. Its sole purpose is to present some concepts in a simplified form as a prelude to the more detailed description below.

In one aspect, a method of treating a crop of a leguminous plant comprises applying to the crop of leguminous plant a solution of 2-chloroethylphosphonic acid comprising: between about 0.5 and about 2 pounds of 2-chloroethylphosphonic acid per acre and nitrogen in an amount of less than 0.3 pounds of nitrogen per acre, wherein the leguminous plant is at a seed growth stage comprising at least one developed seed pod with at least a beginning seed. In some embodiments, the nitrogen is derived from urea. In some embodiments, the nitrogen comprises a water-soluble nitrogen. In some embodiments, the solution of 2-chloroethylphosphonic acid further comprises zinc and a spreader-sticker.

Other aspects, embodiments, and features of this disclosure will become apparent in the following written description.

### DETAILED DESCRIPTION

As a result of efforts to accelerate plant maturation and ripening of a leguminous plant crop such as soybeans, navy beans, kidney beans, pinto beans, black beans and other related bean plant crops, the inventor has found that, when treated with a solution of 2-chloroethylphosphonic acid comprising nitrogen as described herein, the legumes of a leguminous plant crop are ready for harvest days and weeks ahead of untreated plants. This acceleration saves time, energy, and resources for the crop producer. Moreover, application of the solution described herein helps the leguminous plant crop tolerate frost and survive unexpected freezing temperatures. Thus, with the application of the solution described herein, with notice of an unexpected freeze, the leguminous plant crop will be in a better position to tolerate and survive colder temperatures into mature growth stages.

The 2-chloroethylphosphonic acid solution used in the method of the present invention is generally soluble in water and can be applied to plants in aqueous solutions. Aqueous solutions described herein may be partially or wholly composed of water as a suitable liquid medium. However, other liquid mediums may also be used so long as they are non-toxic. Application may be accomplished using conventional equipment known in the art.

The precise amounts of the components of the 2-chloroethylphosphonic acid solution described herein will depend upon the particular leguminous plant species being treated. By way of example, an amount of about 0.75 pounds of 2-chloroethylphosphonic acid per acre at the R-6 stage has shown significant acceleration of maturation in bean plants. Approximately one half of this amount (approximately 0.3875 pounds per acre) has yielded similar acceleration. The amount of 2-chloroethylphosphonic acid should be nonphytotoxic with respect to the leguminous plant being treated.

A leguminous plant refers to any plant in the legume family including beans, soybeans, peas, nuts, and lentils. In some embodiments, the leguminous plant is one of: soybeans, navy beans, kidney beans, pinto beans, and black beans. By applying an effective amount of the 2-chloroethylphosphonic acid solution described herein to a leguminous plant when the leguminous plant reaches at least an R5 stage of growth, the maturation of the seeds of the leguminous plant is reached quicker than when left untreated. “R” refers to the reproductive stage of soybean growth. R5 refers to the beginning seed stage. For soybeans, this stage entails one-eighth inch long seeds in a pod at one of the four uppermost nodes on the main stem with a fully developed leaf. R6 refers to the full seed stage. This entails a pod containing a green seed that fills the pod cavity on one of the four uppermost nodes on the main stem with a fully developed leaf. R5.5 refers to the stage in between R5 and R6. In some cases, maturation is achieved up to 30 days faster than when not treated as described herein. In certain embodiments, maturation is achieved by up to 20 days. In certain embodiments, maturation is achieved by up to 25 days.

The composition used in the process of the present invention is preferably applied to growing plants, as set forth in the examples in this specification. The solution of 2-chloroethylphosphonic acid described herein achieves improved results in particular for soybean crops when applied during at least an R5 stage of growth. In some embodiments, the nitrogen may be sourced from urea. Urea, also known as carbamide, is an organic compound with chemical formula CO(NH₂)₂. The addition of nitrogen provides for a higher yield of spreadable solution to inhibit unwanted plant growth and trigger senescence of a leguminous plant, thereby causing rapid maturation of the legumes and minimizing the days needed to reach a harvesting stage.

The solution of 2-chloroethylphosphonic acid may be prepared by mixing together 2-chloroethylphosphonic acid (known as ethephon in liquid form and obtainable from a number of sources), nitrogen, and a spreader-sticker with a water solution or non-toxic liquid medium. Most commercial sprayers are suitable for preparation and/or application of the solution described herein. To prepare the mixture, during test runs, a tank comprising a capacity of 600 gallons and an agitator was used. Continuous agitation of the mixture during preparation seems to provide best results. In embodiments utilizing urea, a water-soluble urea comprising approximately 46% nitrogen in dry form may be first added to water, as this is often the most difficult component to mix into the solution. Once the urea is substantially dissolved, the 2-chloroethylphosphonic acid was added in some test runs. In some embodiments, a spreader-sticker is lastly added to the mix. Mixing is performed continuously in certain embodiments. During some test runs, approximately 4 pounds of urea per acre was added to about 10 gallons (83.4 pounds) of water per acre, followed by approximately 1.5 pounds of 2-chloroethylphosphonic acid per acre. A spreader-sticker was then added at a rate of 2 ounces (0.125 pounds) per acre. In certain embodiments, the combining step may be performed by sequentially adding water and then the 2-chloroethylphosphonic acid. In other embodiments, the preparing of the solution comprises first combining urea with the water prior to adding the 2-chloroethylphosphonic acid into a single mixing device. In some embodiments, the combining may comprise alternately or intermittently adding the components to the water to obtain suitable concentrations.

In some embodiments, the spreader-sticker is silicone-based. A suitable silicone-based spreader-sticker, for example, is Kinetic by Helena. Other non-silicone-based sticker-spreaders may also be used in some embodiments.

In other embodiments, the solution of 2-chloroethylphosphonic acid to be applied to a leguminous plant crop comprises nitrogen from a nitrogen-containing substance comprising at least about 15% total nitrogen. In some embodiments, the nitrogen-containing substance comprises about 5% zinc.

Generally, application should be performed when the leguminous plant is at least at a seed growth stage where the leguminous plant comprises at least one developed seed pod with at least one beginning seed developing. Application of the 2-chloroethylphosphonic acid solution is believed to trigger maturation of the legumes. In some embodiments, the leguminous plant may be at growth stage R5 when application of the solution described herein is performed. During R5, a fully developed seed pod may comprise, for example, a match-head sized seed in the pod. In some embodiments, the leguminous plant may be at growth stage R5.5, or between R5 and R6 for application. In some embodiments, the leguminous plant may be at growth stage R6, when a fully developed seed pod may comprise, for example, a fully sized seed. In some embodiments, the leguminous plant may be at growth stage R6.5, or at or between R6 and R7. During test runs, beneficial growth was also achieved at the R7 growth stage, with senescence triggered up to 5 days after application to achieve a crop that is ready to harvest. These stages are readily determined by those skilled in the art. By way of example, prior to application, the physiological stage of the leguminous plant may be determined by inspecting the terminal (or last growing point at the top) end of the leguminous plant crop for a seed pod. Generally, a growth stage is labeled as such when 50% or more of the plants are in or beyond that growth stage. Good results have been obtained when applying the solution at or between growth stages R5 and R7, to speed up the harvesting stage. Triggering maturation at the growth stage R5 may produce smaller seeds. For commercial production, triggering at R6 may be most successful to obtain more seed at a greater weight. In some embodiments, the applying step is performed when 92% of the leguminous plant crop is in the R5 growth stage. In some embodiments, the applying step is performed when 90% of the leguminous plant crop is in the R5.5 growth stage. In some embodiments, the applying step is performed when between 96-98% of the leguminous plant crop is in the R6 growth stage.

At temperatures above a 95° F. heat index, it may be difficult to allow the solution to beneficially permeate the leguminous plant crop. Morning applications may therefore be preferable. In certain embodiments, application of the solution described herein may perform best at temperatures below 98° F. In some embodiments, application of the solution may perform best at temperature below about 90° F.

During trial runs, soybean plant crops were planted on plot sizes ranging from 25-150 acres. Soybean plant crops were planted on soil used for rotational crops including, for example, grass crop, corn crop, or grain crop. Crops were seeded approximately 1-1.5 inches deep with a twin line planter. No other pretreatments were performed on the soil during test runs. Ground application was performed on raised beds using a flow jet capable of delivering a minimum of 10-20 gallons per acre. Raised beds were used during some test runs. Furrow irrigation was used to water the soybean plant crop, applying water to the top end of each furrow. Using the application as described herein, exceptional field performance in significantly lower time frames than the typical minimum 39-day period, with germination rates as high as 90% and above have been achieved. In some cases, roughly 30 days have been shaved off waiting times.

In some embodiments, the step of applying a 2-chloroethylphosphonic acid solution comprises directly applying the 2-chloroethylphosphonic acid solution to the foliage and stems of a bean plant. In some embodiments, the step of applying a 2-chloroethylphosphonic acid solution comprises directly applying the 2-chloroethylphosphonic acid solution to the soil in which a bean plant is growing. Direct application may be accomplished, for example, via an irrigation system. In such embodiments, the compound will be root-absorbed to a sufficient extent so as to result in accelerated bean maturation described herein. In some embodiments, the method comprises applying the 2-chloroethylphosphonic acid solution to a bean plant crop at a rate of at least about 0.375 pounds of 2-chloroethylphosphonic acid per acre. Application may also be performed at the rate of up to about 1.5 pounds per acre in some embodiments. Accelerated maturations of a bean plant was achieved in some cases when applied at the plant development stage known as R-6 using about 0.75 pounds of 2-chloroethylphosphonic acid per acre.

The exact mechanism behind why the application shortens plant maturation is unknown. 2-chloroethylphosphonic acid is an ethylene donor during cultivation of some beans and this may play a role in the maturation of the bean. The acceleration of bean maturing in these plants may also be due to the inhibition of leaf growth and in the growth of other parts of the plant thereby freeing up nutrients that are then redirected towards the harvestable beans. While the reasoning remains unknown, the method and solution described herein have significantly improved turnaround times to harvest and this remains a desirable benefit for the food supply chain upon which consumers depend throughout the year.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. As used herein, “up to” includes zero, meaning no amount (i.e, 0%) is added in some embodiments.

Unless otherwise specified, all percentages, parts and ratios refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as subsequently indicated as well as to values that are within statistical variations or measuring inaccuracies.

The methods disclosed herein may be suitably practiced in the absence of any element, limitation, compound, or step that is not specifically disclosed herein. Similarly, specific devices described herein may be free of any component not specifically described herein.

While the invention has been particularly shown and described with reference to certain embodiments, it will be understood by those skilled in the art that various changes in form and detail may be made therein without departing from the spirit and scope of the invention.

### ADDITIONAL DESCRIPTION

The following clauses are offered as further description of the disclosed invention.

Clause 1. A method of treating a crop of a leguminous plant, the method comprising applying to the crop of leguminous plant a solution of 2-chloroethylphosphonic acid comprising: between about 0.5 and about 2 pounds of 2-chloroethylphosphonic acid per acre and nitrogen in an amount of less than 0.3 pounds of nitrogen per acre, wherein the leguminous plant is at a seed growth stage comprising at least one developed seed pod with at least a beginning seed.

Clause 2. The method of any proceeding claim wherein the nitrogen is derived from urea.

Clause 3. The method of any proceeding claim wherein the nitrogen comprises water soluble nitrogen.

Clause 4. The method of any proceeding claim wherein the solution of 2-chloroethylphosphonic acid further comprises an amount of zinc.

Clause 5. The method of any proceeding claim wherein the solution of 2-chloroethylphosphonic acid further comprises a spreader-sticker in an amount of up to about 0.125 pounds per acre.

Clause 6. The method of any proceeding claim wherein the spreader-sticker is a silicone-based spreader sticker.

Clause 7. The method of any proceeding claim wherein the solution of 2-chloroethylphosphonic acid is applied at a rate of at least about 0.375 pounds of 2-chloroethylphosphonic acid per acre.

Clause 8. The method of any proceeding claim wherein the solution of 2-chloroethylphosphonic acid is applied at a rate of up to about 1.5 pounds per acre.

Clause 9. The method of any proceeding claim wherein the leguminous plant is a soybean plant.

Clause 10. The method of any proceeding claim wherein the seed growth stage is at least R5.

Clause 11. The method of any proceeding claim wherein the seed growth stage is between about R5 and R7.

Clause 12. The method of any proceeding claim wherein the leguminous plant comprises foliage and the applying step comprises applying the water-based solution of 2-chloroethylphosphonic acid directly to the foliage of the leguminous plant.

Clause 13. A composition for triggering senescence of a leguminous plant crop, the composition comprising per acre of crop:

between about 0.5 and about 2 pounds of 2-chloroethylphosphonic acid; nitrogen in an amount of less than 0.3 pounds of nitrogen; and a spreader sticker.

Clause 14. The composition of any proceeding claim wherein the composition is water-soluble.

Clause 15. The composition of any proceeding claim comprising an amount of zinc.

Clause 16. The solution of any proceeding claim wherein the spreader-sticker is silicone-based.

What is claimed is:

1. A method of treating a crop of a leguminous plant, the method comprising applying to the crop of leguminous plant a solution of 2-chloroethylphosphonic acid comprising: between about 0.5 and about 2 pounds of 2-chloroethylphosphonic acid per acre and nitrogen in an amount of less than 0.3 pounds of nitrogen per acre, wherein the leguminous plant is at a seed growth stage comprising at least one developed seed pod with at least a beginning seed.

2. The method of claim 1 wherein the nitrogen is derived from urea.

3. The method of claim 1 wherein the nitrogen comprises water soluble nitrogen.

4. The method of claim 1 wherein the solution of 2-chloroethylphosphonic acid further comprises an amount of zinc.

5. The method of claim 1 wherein the solution of 2-chloroethylphosphonic acid further comprises a spreader-sticker in an amount of up to about 0.125 pounds per acre.

6. The method of claim 5 wherein the spreader-sticker is a silicone-based spreader sticker.

7. The method of claim 1 wherein the solution of 2-chloroethylphosphonic acid is applied at a rate of at least about 0.375 pounds of 2-chloroethylphosphonic acid per acre.

8. The method of claim 1 wherein the solution of 2-chloroethylphosphonic acid is applied at a rate of up to about 1.5 pounds per acre.

9. The method of claim 1 wherein the leguminous plant is a soybean plant.

10. The method of claim 1 wherein the seed growth stage is at least R5.

11. The method of claim 1 wherein the seed growth stage is between about R5 and R7.

12. The method of claim 1 wherein the leguminous plant comprises foliage and the applying step comprises applying the water-based solution of 2-chloroethylphosphonic acid directly to the foliage of the leguminous plant.

13. A composition for triggering senescence of a leguminous plant crop, the composition comprising per acre of crop:
between about 0.5 and about 2 pounds of 2-chloroethylphosphonic acid;
nitrogen in an amount of less than 0.3 pounds of nitrogen; and
a spreader sticker.

14. The composition of claim 13 wherein the composition is water-soluble.

15. The composition of claim 13 comprising an amount of zinc.

16. The solution of claim 13 wherein the spreader-sticker is silicone-based.
